(19) United States
(12) Patent Application Publication
(10) Pub. No.: US 2017/0345081 A1
(43) Pub. Date: Nov. 30, 2017

(54) INFORMATION PROCESSING DEVICE, INFORMATION PROCESSING SYSTEM AND INFORMATION PROCESSING METHOD

(71) Applicant: FUJITSU LIMITED, Kawasaki-shi (JP)

(72) Inventors: Akira Itasaki, Yokohama (JP); Akira FUJII, Machida (JP); Kazumasa USHIKI, Kawasaki (JP); NARUHIRO KUSUMINE, Kawasaki (JP)

(73) Assignee: FUJITSU LIMITED, Kawasaki-shi (JP)

(21) Appl. No.: 15/490,311

(22) Filed: Apr. 18, 2017

(30) Foreign Application Priority Data
May 30, 2016 (JP) 2016-107660

(51) Int. Cl. G06Q 30/06; H04W 4/02

(52) U.S. Cl. CPC G06Q 30/0635; H04W 4/02

(57) ABSTRACT

An information processing device includes a feature amount receiving unit that receives predetermined feature amount information including times at which a plurality of terminals pass a specific location from the terminals and stores the received feature amount information in a storage unit in association with the terminals; and a group decision unit that groups terminals associated with same or approximate feature amount information based on the received feature amount and the feature amount information already stored in the storage unit and that stores the grouped terminals in a group information storage unit in association with an identifier for identifying a group.

### CROSS-REFERENCE TO RELATED APPLICATION(S)

This application is based upon and claims the benefit of priority of the prior Japanese Patent Application No. 2016-107660, filed on May 30, 2016, the entire contents of which are incorporated herein by reference.

### FIELD

The embodiments discussed herein are related to an information processing device and the like.

### BACKGROUND

When a plurality of persons use a shop, there is a need for each of the persons to grasp a total purchase amount of the persons even if they are acting separately from each other. This is because, for example, each of the persons learns the discount amount of a parking fee corresponding to the total purchase amount or the number of times of holding a lottery corresponding to the total purchase amount.

A technology in which each of persons grasps the total purchase amount of the persons is known (see, for example, Japanese Laid-open Patent Publication No. 2002-203283 and Japanese Laid-open Patent Publication No. 2003-109116). In the technology, when receiving goods purchase information from a shop terminal, a processor processes or extracts the received information and creates the goods purchase information in a predetermined format. The processor retrieves an affiliated customer group ID from a customer database using a customer ID of the goods purchase information as a key, checks the affiliated customer group ID against a purchase condition table when it is retrieved, calculates the number of points purchased this time, adds the point(s) to corresponding customer group cumulative points in the customer database of the group, and displays the result of the addition on a shop terminal. Aggregation of the points is performed by unit such as previously registered family, specific small group, and a group of customers who join the group.

However, there is a problem that it is difficult to respond to a case in which a plurality of persons are temporarily grouped in the conventional technology. For example, when each of the persons is to grasp the total purchase amount of the persons, the processor previously groups the persons and adds the purchase amount of the grouped persons. Therefore, when the persons are to be temporarily grouped, it is difficult to add the purchase amount of the grouped persons for the processor. In other words, it is difficult to handle for the processor the case in which the persons are temporarily grouped.

### SUMMARY

According to an aspect of an embodiment, an information processing device includes a processor and a storage unit. The processor executes a process. The process includes receiving predetermined feature amount information including times when a plurality of terminals pass a specific location from the terminals. The process includes storing the feature amount information received at the receiving in the storage unit in association with the terminal. The process includes grouping terminals associated with same or approximate feature amount information based on the feature amount information received at the receiving and the feature amount information already stored in the storage unit. The processor includes storing the terminals grouped at the grouping in the storage unit in association with an identifier for identifying a group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of an information processing system including a server according to a first embodiment;

FIG. 2 is a diagram illustrating an example of a data structure of a group ID storage unit according to the first embodiment;

FIG. 3 is a diagram illustrating an example of a data structure of a group information storage unit according to the first embodiment;

FIG. 4 is diagram illustrating an example of a data structure of a purchase information storage unit according to the first embodiment;

FIG. 5 is a diagram illustrating an application of the information processing system according to the first embodiment;

FIG. 6 is a diagram illustrating a flowchart of application delivery processing of the server according to the first embodiment;

FIG. 7 is a diagram illustrating a flowchart of grouping processing in the server according to the first embodiment;

FIG. 8 is a diagram illustrating a flowchart of purchase information processing of the server according to the first embodiment;

FIG. 9 is a diagram illustrating a flowchart of feature amount extraction processing of a terminal according to the first embodiment;

FIG. 10A is a diagram illustrating a flowchart of purchase information processing of the terminal according to the first embodiment;

FIG. 10B is a diagram illustrating a flowchart of purchase information notification processing of the terminal according to the first embodiment;

FIG. 11 is a diagram illustrating an example of a display screen according to the first embodiment;

FIG. 12 is a diagram illustrating a sequence of the grouping processing according to the first embodiment;

FIG. 13 is a diagram illustrating a sequence of the purchase information processing according to the first embodiment;

FIG. 14 is a block diagram illustrating a functional configuration of an information processing system including a server according to a second embodiment;

FIG. 15 is a diagram illustrating an example of a data structure of a group information storage unit according to the second embodiment;

FIG. 16 is a diagram illustrating an application of the information processing system according to the second embodiment;

FIG. 17A is a diagram (1) illustrating a flowchart of grouping processing in the server according to the second embodiment;

FIG. 17B is a diagram (2) illustrating a flowchart of the grouping processing in the server according to the second embodiment;

FIG. 17C is a diagram (3) illustrating a flowchart of the grouping processing in the server according to the second embodiment;

FIG. 18 is a diagram illustrating a flowchart of feature amount extraction processing of a terminal according to the second embodiment;

FIG. 19 is a diagram illustrating an example of a sequence of the display screen; and

FIG. 20 is a diagram illustrating an example of a computer executing an information processing program.

### DESCRIPTION OF EMBODIMENTS

Preferred embodiments of the present invention will be explained with reference to accompanying drawings. The present invention is not limited to the the embodiments.

### [a] First Embodiment

Configuration of Information Processing System According to First Embodiment

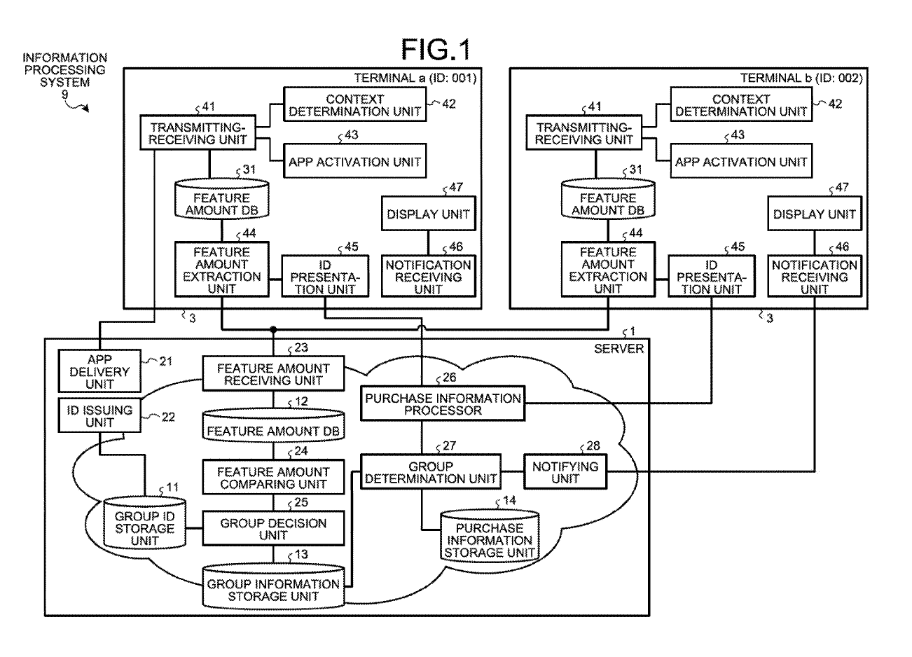

FIG. 1 is a block diagram illustrating a functional configuration of an information processing system including a server according to a first embodiment. As illustrated in FIG. 1, an information processing system 9 includes a server 1 and a plurality of terminals 3. Although there are two terminals 3 in FIG. 1, the number is not limited thereto. When services can be enjoyed by grouping unit in which users are temporarily grouped, the information processing system 9 temporarily groups the users by using sensing information and context via the terminals 3 owned by the users. As an example of the services, there is a service that informs a plurality of users in a group of the time to enjoy free service of parking time and of a purchase amount needed for enjoying the free service of parking time from time to time even when the users in the same car visit a predetermined facility and purchase goods separately in the facility. In order to implement the system, the server 1 of the information processing system 9 receives predetermined feature amount information including times at which the terminals pass through a specific location from the terminals 3, and stores the received feature amount information in a storage unit in association with the respective terminals 3. The server 1 groups the terminals 3 associated with the same or approximate feature amount information based on the feature amount information stored in the storage unit and already stored feature amount information. The server 1 stores the grouped terminals 3 in the storage unit in association with an identifier for identifying a group. A case in which a plurality of users in the same car are grouped will be explained in the first embodiment.

The server 1 includes a group ID storage unit 11, a feature amount database (DB) 12, a group information storage unit 13, and a purchase information storage unit 14.

The group ID storage unit 11 stores a group ID (IDentifier) for identifying the group in association with the time when the group ID is issued. The group ID may be the same as a parking ticket ID issued, for example, when the car is parked. The feature amount DB 12 stores a feature amount of each terminal used to group terminals. In the first embodiment, the feature amount information indicates time information at which the terminal receives a radio wave when the radio wave is transmitted by a beacon. Specifically, the feature amount DB 12 stores a user ID in association with the time information indicated as the feature amount. The group information storage unit 13 stores group information in which the user ID is associated with the group ID. The purchase information storage unit 14 stores purchase information in association with each group. Each data structure of the group ID storage unit 11, the group information storage unit 13, and the purchase information storage unit 14 will be explained later.

The server 1 includes an app delivery unit 21, an ID issuing unit 22, a feature amount receiving unit 23, a feature amount comparing unit 24, a group decision unit 25, a purchase information processor 26, and a group determination unit 27.

When receiving a context notification from a terminal 3, the app delivery unit 21 delivers an application to the terminal 3. The application mentioned here indicates an application (grouping app) used for the server 1 to communicate with the terminal 3 and group it.

The ID issuing unit 22 issues a group ID such as a parking ticket ID. The ID issuing unit 22 stores the issued group ID in the group ID storage unit 11 together with the issuing time. The ID issuing unit 22 is included in the server 1 but is not limited thereto, and may be included in an individual ticket-vending machine. When included in the ticket-vending machine, the ID issuing unit 22 only has to transmit the issued group ID together with the time when it is issued to the server 1.

The feature amount receiving unit 23 receives the feature amount transmitted from each terminal 3 and stores the received feature amount in the feature amount DB 12 in association with the terminal 3.

The feature amount comparing unit 24 compares the feature amounts acquired from the terminals 3 and calculates whether the grouping of the terminals 3 is possible. For example, the feature amount comparing unit 24 compares the feature amount currently acquired from the terminal 3 with the feature amount stored in the feature amount DB 12.

The group decision unit 25 decides that terminals 3 associated with the same or approximate feature amount are grouped as a result of the comparison performed by the feature amount comparing unit 24. For example, the group decision unit 25 acquires the terminals associated with the same or the approximate feature amount from the feature amount DB 12 as a result of the comparison performed by the feature amount comparing unit 24, and decides that the acquired terminals 3 are grouped. In other words, the group decision unit 25 groups the terminals 3 in which the times when receiving radio waves transmitted by beacon are the same as or approximate to each other. The group decision unit 25 uses the time associated with the grouped terminals 3 in the feature amount DB 12 to acquire the group ID stored in the group ID storage unit 11. The group decision unit 25 stores the acquired group ID in the group information storage unit 13 in association with the grouped terminals 3. As for “approximation of feature amount”, when the feature amount is time information, a case of, for example, 100 msec to 500 msec is determined as approximation, however, the approximation is not limited thereto. A case of 10 msec to 90 msec may be determined as approximation.

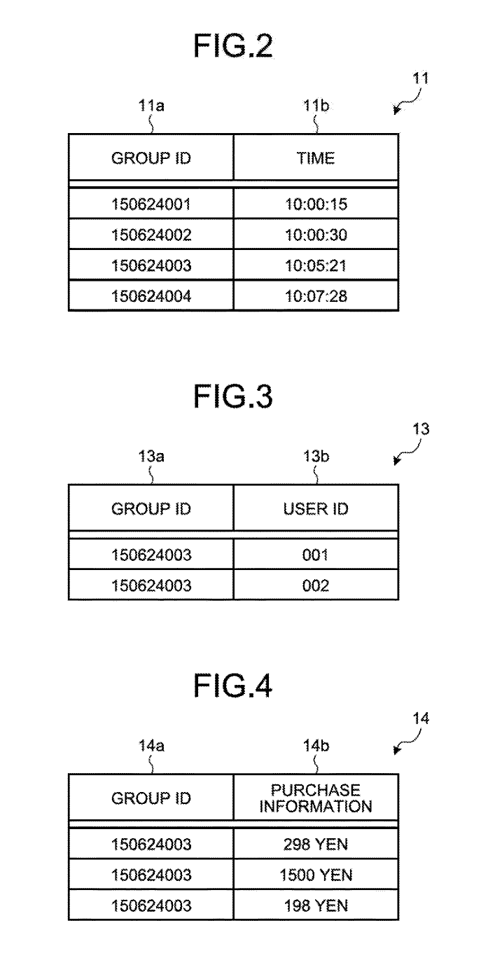

Examples of the data structure of the group ID storage unit 11 and the group information storage unit 13 will be explained below with reference to FIG. 2 and FIG. 3.

FIG. 2 is a diagram illustrating an example of the data structure of the group ID storage unit according to the first embodiment. As illustrated in FIG. 2, the group ID storage unit 11 stores a group ID 11a and a time 11b in association with each other. The group ID 11a indicates an ID for identifying a group. The group ID 11a may be a parking ticket ID. The time 11b indicates the time when the group ID 11a is issued. As an example, when the group ID 11a is “150624003”, “10:05:21” is stored as the time 11b.

FIG. 3 is a diagram illustrating an example of the data structure of the group information storage unit according to the first embodiment. As illustrated in FIG. 3, the group information storage unit 13 stores a group ID 13a and a user ID 13b in association with each other. The group ID 13a indicates an ID for identifying a group. The user ID 13b indicates an ID for identifying a user corresponding to a terminal 3, which is an ID managed by, for example, the terminal 3. As an example, when the group ID 13a is “150624003”, “001” and “002” are stored as the user ID 13b.

Returning to FIG. 1, the purchase information processor 26 processes purchase information. For example, when receiving the purchase information, the purchase information processor 26 acquires the user ID presented from the terminal 3 of the user who purchases goods.

The group determination unit 27 determines a group of purchase information. For example, the group determination unit 27 uses the user ID acquired when the purchase information processor 26 processes the purchase information to acquire the group ID 13a from the group information storage unit 13. The group determination unit 27 then associates the acquired group ID with the purchase information and updates the purchase information storage unit 14.

A notifying unit 28 notifies purchase information and additional information to the terminals 3 belonging to the group associated with the purchase information. The additional information includes, for example, a time when the free service of parking time can be enjoyed and a purchase amount needed for enjoying the free service of the parking time.

An example of the data structure of the purchase information storage unit 14 will be explained below with reference to FIG. 4.

FIG. 4 is diagram illustrating an example of the data structure of the purchase information storage unit according to the first embodiment. As illustrated in FIG. 4, the purchase information storage unit 14 stores a group ID 14a and purchase information 14b in association with each other. The group ID 14a indicates an ID for identifying a group. The purchase information 14b indicates a purchase amount. As an example, when the group ID 14a is “150624003”, “298 yen”, “1500 yen”, and “198 yen” are stored as the purchase information 14b.

The terminal 3 includes a feature amount DB 31. The feature amount DB 31 stores a received signal strength indication (RSSI) value indicating a radio field intensity when the terminal 3 receives a radio wave of a beacon and the received time information. The time information is a feature amount herein.

The terminal 3 includes a transmitting-receiving unit 41, a context determination unit 42, an app activation unit 43, a feature amount extraction unit 44, an ID presentation unit 45, a notification receiving unit 46, and a display unit 47.

When receiving the radio wave from the beacon used to acquire the feature amount, the transmitting-receiving unit 41 stores the received RSSI value indicating the radio field intensity and the received time information in the feature amount DB 31. The beacon used to acquire the feature amount will be hereinafter referred to as “beacon β” and explained.

When receiving a radio wave from a beacon different from the beacon used to acquire the feature amount, the transmitting-receiving unit 41 transmits a notification (hereinafter, called “context notification”) indicating transition to the context to the server 1. The beacon different from the beacon used to acquire the feature amount is a beacon used to deliver an application, and will be hereinafter referred to as “beacon α” and explained. The “context notification” mentioned here indicates notification indicating that the terminal transitions to an estimated location based on the radio wave of the beacon α. The transmitting-receiving unit 41 also receives an application to be delivered according to the context notification.

The context determination unit 42 determines whether the terminal has transitioned to the context based on the radio wave of the beacon α. When it is determined that the terminal has transitioned to the context, the context determination unit 42 causes the transmitting-receiving unit 41 to transmit the context notification.

When the transmitting-receiving unit 41 receives the application, the app activation unit 43 activates the received application.

The feature amount extraction unit 44 extracts time information when the RSSI value becomes maximum from the information stored in the feature amount DB 31. The feature amount is the time information herein. The feature amount extraction unit 44 transmits the extracted time information and the user ID presented from the ID presentation unit 45, which is explained later, to the server 1.

The ID presentation unit 45 presents the user ID to the feature amount extraction unit 44. When the user carrying the terminal 3 purchases goods, the ID presentation unit 45 presents the user ID to the server 1. It is explained that the ID presentation unit 45 presents the user ID, but the embodiment is not limited thereto. Therefore, the terminal ID may be presented.

The notification receiving unit 46 receives a notification indicating the purchase information and the additional information of the terminals 3 belonging to the same group from the server 1.

The display unit 47 displays the purchase information and the additional information received by the notification receiving unit 46.

Application of Information Processing System

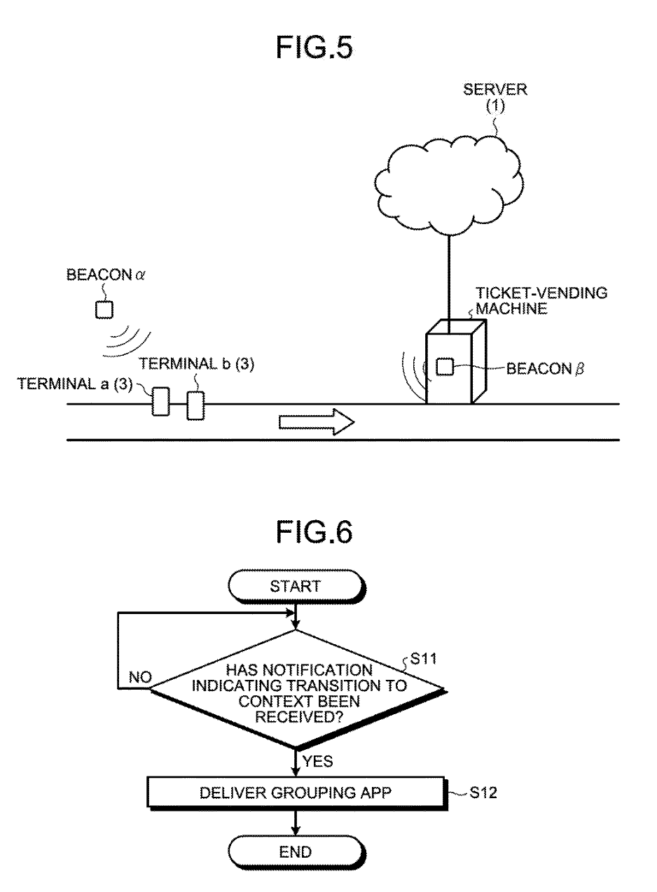

FIG. 5 is a diagram illustrating an application of the information processing system according to the first embodiment. As illustrated in FIG. 5, the server 1 is connected to the ticket-vending machine that issues a parking ticket when a car is parked. The beacon β is built in the ticket-vending machine. Apart from the beacon β, the beacon α is disposed in the direction opposite to the traveling direction of the car with respect to the ticket-vending machine. It is assumed that the ticket-vending machine is provided outside the server 1.

Under such circumstances, it is assumed that a car carrying a user with a terminal a (3) and a user with a terminal b (3) has progressed and passed through the beacon α. Then, in each of the terminals a and b (3), when detecting the radio wave of the beacon α, the context determination unit 42 determines that the terminal has transitioned to the context. The transmitting-receiving unit 41 then transmits the context notification to the server 1 and receives an application corresponding to the context notification from the server 1, and the app activation unit 43 activates the received application.

The car goes further and is about to pass the beacon β.

Then, in each of the terminals a and b (3), the feature amount extraction unit 44 stores the RSSI value and the detected time information in the feature amount DB 31 each time the radio wave of the beacon β is detected. The feature amount extraction unit 44 extracts the time information at which the RSSI value becomes maximum, as the feature amount, from the information stored in the feature amount DB 31. The feature amount extraction unit 44 then transmits the extracted time information and the user ID to the server 1.

In the ticket-vending machine, when the car passes, the ID issuing unit 22 issues a group ID and transmits the issued group ID to the server 1 together with the issuing time. The server 1 stores the group ID and the time information transmitted from the ticket-vending machine in the group ID storage unit 11.

In the server 1, when receiving the time information and the user ID transmitted from each of the terminal a (3) and the terminal b (3), the feature amount receiving unit 23 stores them in the feature amount DB 12. The feature amount comparing unit 24 compares the pieces of time information stored in the feature amount DB 12 as feature amounts. The group decision unit 25 acquires the terminal a (3) and the terminal b (3) associated with the same or the approximate feature amount as a result of the comparison from the feature amount DB 12, and decides to group the acquired terminal a (3) and terminal b (3). The group decision unit 25 uses the time associated with the terminal a (3) and the terminal b (3) grouped in the feature amount DB 12 to acquire the group ID stored in the group ID storage unit 11. The group decision unit 25 stores the acquired group ID in the group information storage unit 13 in association with the grouped terminal a (3) and terminal b (3).

Flowchart of Application Delivery Processing of Server

An example of the procedure of application delivery processing of the server 1 according to the first embodiment will be explained below with reference to FIG. 6. FIG. 6 is a diagram illustrating a flowchart of the application delivery processing of the server according to the first embodiment.

As illustrated in FIG. 6, in the server 1, the app delivery unit 21 determines whether a context notification indicating transition to the context has been received from the terminal 3 (Step S11). When it is determined that the context notification indicating transition to the context has not been received (No at Step S11), the app delivery unit 21 repeats the determination processing until the context notification is received.

Meanwhile, when it is determined that the context notification indicating transition to the context has been received (Yes at Step S11), the app delivery unit 21 delivers the grouping app to the terminal 3 (Step S12). Then, the app delivery unit 21 ends the application delivery processing.

Flowchart of Grouping Processing in Server

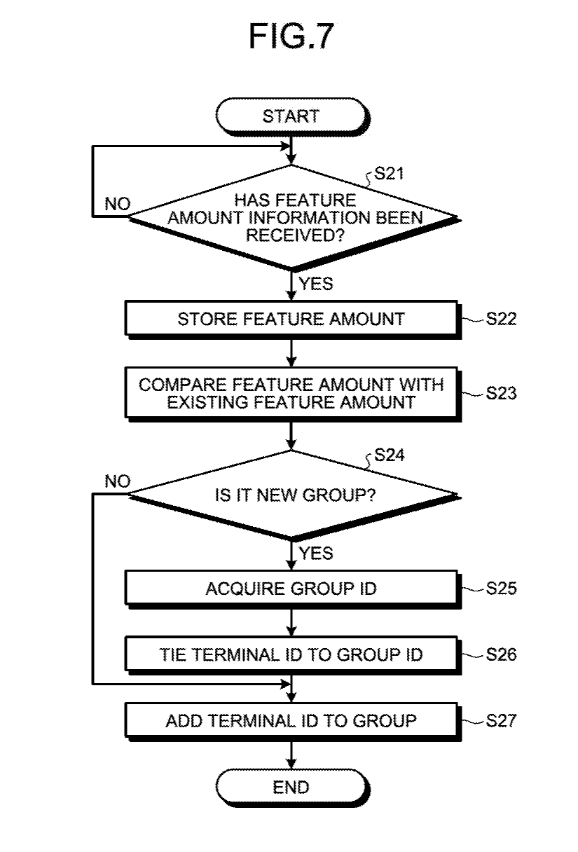

An example of the procedure of grouping processing in the server 1 according to the first embodiment will be explained below with reference to FIG. 7. FIG. 7 is a diagram illustrating a flowchart of grouping processing in the server according to the first embodiment.

As illustrated in FIG. 7, in the server 1, the feature amount receiving unit 23 determines whether feature amount information has been received (Step S21). When it is determined that the feature amount information has not been received (No at Step S21), the feature amount receiving unit 23 repeats the determination processing until the feature amount information is received.

Meanwhile, when it is determined that the feature amount information has been received (Yes at Step S21), the feature amount receiving unit 23 stores the feature amount information (Step S22). For example, the feature amount receiving unit 23 stores the feature amount in the feature amount DB 12 in association with the terminal ID of the terminal 3 that transmits the feature amount (Step S22). The feature amount comparing unit 24 compares the received feature amount with the existing feature amount in the feature amount DB 12 (Step S23).

The group decision unit 25 determines whether the group is a new group as a result of comparison performed by the feature amount comparing unit 24 (Step S24). For example, the group decision unit 25 determines whether the feature amount matches (or is approximate to) the existing feature amount and is a first time. In other words, when it is determined that the feature amount matches (or is approximate to) the existing feature amount and is the first time, the group decision unit 25 determines that the group is the new group, and determines that it is not the new group when it is determined that the feature amount matches (or is approximate to) the existing feature amount but is not the first time.

When it is determined that the group is not the new group (No at Step S24), the group decision unit 25 proceeds to Step S27. Meanwhile, when it is determined that the group is the new group (Yes at Step S24), the group decision unit 25 uses the matching feature amount to acquire the group ID stored in the group ID storage unit 11 (Step S25).

The group decision unit 25 then ties the terminal ID associated with the matching feature amount to the acquired group ID (Step S26). The group decision unit 25 stores the tied terminal ID and the group ID in the group information storage unit 13 in association with each other, and proceeds to Step S27.

At Step S27, the group decision unit 25 adds the terminal ID associated with the received feature amount to the group of the acquired group ID (Step S27). In other words, the group decision unit 25 adds the terminal ID in association with the group ID to the group information storage unit 13. The group decision unit 25 then ends the grouping processing.

Flowchart of Purchase Information Processing of Server

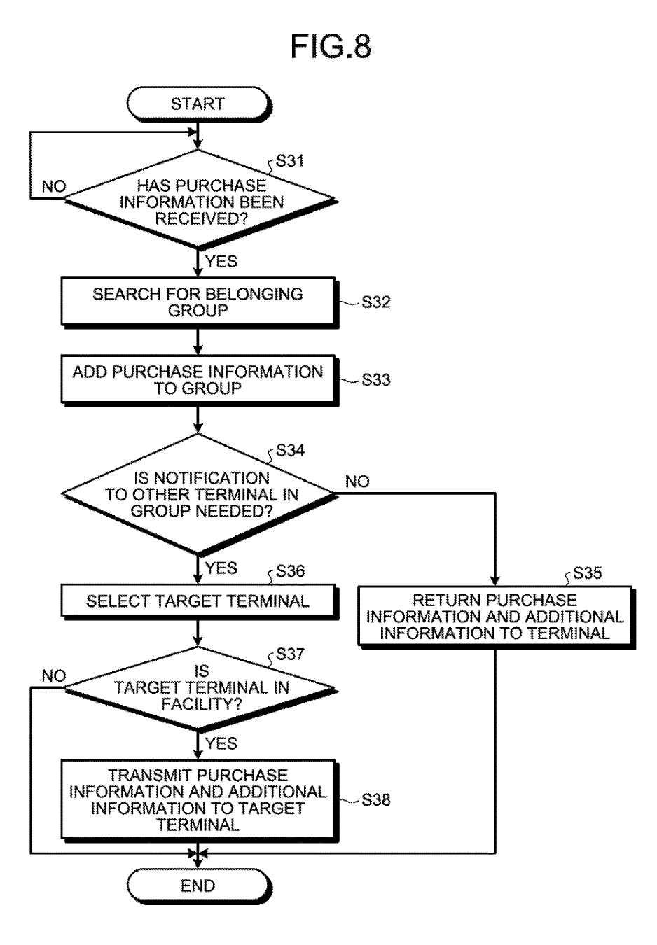

An example of the procedure of purchase information processing of the server 1 according to the first embodiment will be explained below with reference to FIG. 8. FIG. 8 is a diagram illustrating a flowchart of purchase information processing of the server according to the first embodiment.

As illustrated in FIG. 8, in the server 1, the purchase information processor 26 determines whether purchase information has been received from the terminal 3 (Step S31). When it is determined that the purchase information has not been received (No at Step S31), the purchase information processor 26 repeats the determination processing until the purchase information is received.

Meanwhile, when it is determined that the purchase information has been received (Yes at Step S31), the group determination unit 27 uses the terminal ID presented from the terminal 3 of the user who purchases goods to search for a group ID from the group information storage unit 13 (Step S32). Then, the group determination unit 27 adds the purchase information to the group of the searched group ID (Step S33). In other words, the group determination unit 27 adds the searched group ID in association with the purchase information to the purchase information storage unit 14.

Subsequently, the notifying unit 28 determines whether notification to other terminal 3 in the group is needed (Step S34). When it is determined that no notification to other terminal 3 in the group is needed (No at Step S34), the notifying unit 28 returns the purchase information and the additional information to the terminal 3 of the user who purchases goods (Step S35). The additional information includes, for example, a time when the free service of parking time can be enjoyed and a purchase amount needed for enjoying the free service of the parking time. Then, the notifying unit 28 ends the notification processing.

Meanwhile, when it is determined that the notification other terminal 3 in the group is needed (Yes at Step S34), the notifying unit 28 selects a target terminal 3 that needs notification (Step S36). Then, the notifying unit 28 determines whether the target terminal 3 is in the facility (Step S37). When it is determined that the target terminal 3 is not in the facility (No at Step S37), the notifying unit 28 ends the notification processing without notification to the target terminal 3.

Meanwhile, when it is determined that the target terminal 3 is in the facility (Yes at Step S37), the notifying unit 28 transmits the purchase information and the additional information to the target terminal 3 (Step S38). Then, the notifying unit 28 ends the notification processing.

Flowchart of Feature Amount Extraction Processing of Terminal

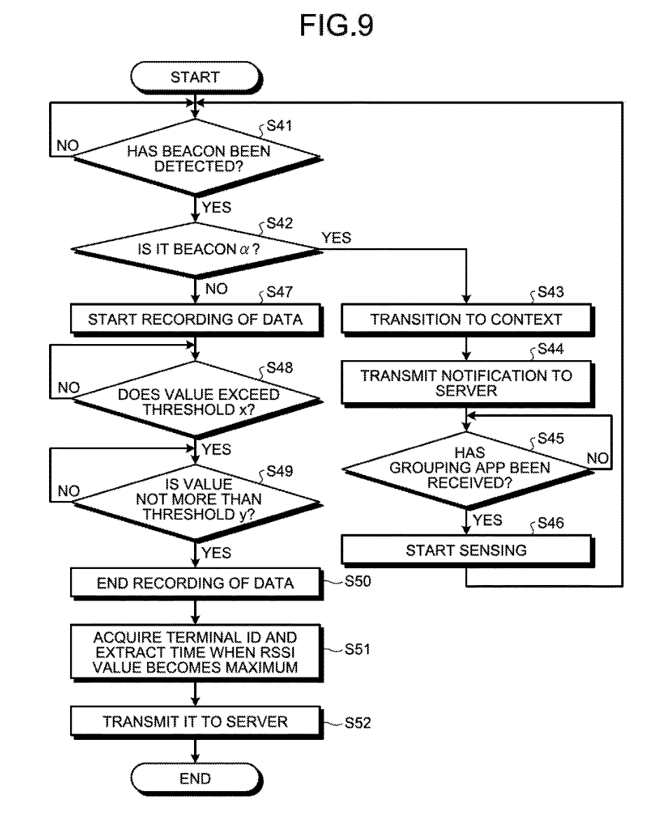

An example of the procedure of feature amount extraction processing of the terminal 3 according to the first embodiment will be explained next with reference to FIG. 9. FIG. 9 is a diagram illustrating a flowchart of the feature amount extraction processing of the terminal according to the first embodiment.

As illustrated in FIG. 9, the transmitting-receiving unit 41 determines whether a beacon has been detected (Step S41). When it is determined that a beacon has not been detected (No at Step S41), the transmitting-receiving unit 41 repeats the determination processing until the beacon is detected. Meanwhile, when it is determined that a beacon has been detected (Yes at Step S41), the transmitting-receiving unit 41 determines whether the detected beacon is a beacon α (Step S42). When it is determined that the beacon is not the beacon α (No at Step S42), the transmitting-receiving unit 41 proceeds to Step S47.

Meanwhile, when it is determined that the beacon is the beacon α (Yes at Step S42), the context determination unit 42 determines that the terminal transmits to the context (Step S43). Then, the transmitting-receiving unit 41 transmits a notification indicating transition to the context (context notification) to the server 1 (Step S44).

The transmitting-receiving unit 41 determines whether the grouping app corresponding to the context notification has been received (Step S45). When it is determined that the grouping app has not been received (No at Step S45), the transmitting-receiving unit 41 repeats the determination processing until the grouping app is received.

Meanwhile, when it is determined that the grouping app has been received (Yes at Step S45), the transmitting-receiving unit 41 starts sensing to detect a radio wave sent from the beacon β (Step S46). The transmitting-receiving unit 41 proceeds to Step S41 in order to detect the beacon.

At Step S47, the transmitting-receiving unit 41 that detects the beacon β starts recording the data (Step S47). In other words, the transmitting-receiving unit 41 stores the RSSI value indicating the radio field intensity when the radio wave is received from the beacon β and the received time information in the feature amount DB 31. The feature amount extraction unit 44 determines whether the RSSI value exceeds a threshold x (Step S48).

When it is determined that the RSSI value does not exceed the threshold x (No at Step S48), the feature amount extraction unit 44 repeats the determination processing until the RSSI value exceeds the threshold x. Meanwhile, when it is determined that the RSSI value exceeds the threshold x (Yes at Step S48), the feature amount extraction unit 44 determines whether the RSSI value is not more than a threshold y (Step S49). When it is determined that the RSSI value is not less than the threshold y (No at Step S49), the feature amount extraction unit 44 repeats the determination processing until the RSSI value becomes not more than the threshold y.

Meanwhile, when it is determined that the RSSI value is not more than the threshold y (Yes at Step S49), the feature amount extraction unit 44 ends the recording of the data (Step S50). Then, the feature amount extraction unit 44 acquires the terminal ID of the own terminal 3 and extracts the time at which the RSSI value becomes maximum from the feature amount DB 31 (Step S51).

The feature amount extraction unit 44 then transmits the feature amount information to the server 1 (Step S52). In other words, the feature amount extraction unit 44 transmits the extracted time as the feature amount together with the terminal ID to the server 1. Then, the feature amount extraction unit 44 ends the feature amount extraction processing.

Flowchart of Purchase Information Processing of Terminal

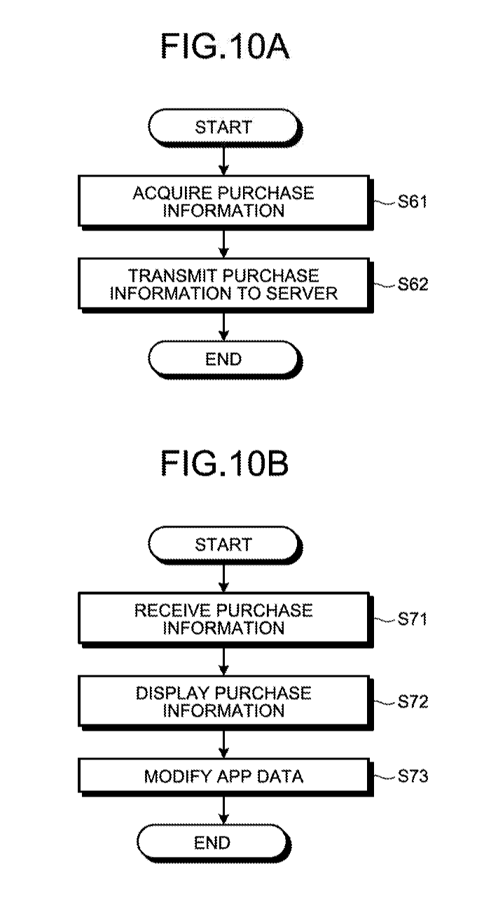

An example of the procedure of purchase information processing of the terminal 3 according to the first embodiment will be explained next with reference to FIG. 10A. FIG. 10A is a diagram illustrating a flowchart of the purchase information processing of the terminal according to the first embodiment.

As illustrated in FIG. 10A, in the terminal 3, when the user purchases goods, the terminal 3 acquires purchase information (Step S61).

The ID presentation unit 45 transmits the purchase information together with the terminal ID to the server 1 (Step S62). The ID presentation unit 45 then ends the purchase information processing.

Flowchart of Purchase Information Notification Processing of Terminal

An example of the procedure of purchase information notification processing of the terminal 3 according to the first embodiment will be explained next with reference to FIG. 10B. FIG. 10B is a diagram illustrating a flowchart of purchase information notification processing of the terminal according to the first embodiment.

As illustrated in FIG. 10B, in the terminal 3, the notification receiving unit 46 receives the purchase information (Step S71). The display unit 47 displays the received purchase information on a screen (Step S72). For example, the display unit 47 displays the purchase information in an additional purchase amount displayed by the application.

The display unit 47 then modifies the application data (Step S73). For example, the display unit 47 adds the additional purchase amount to a total purchase amount and displays the total purchase amount added with the additional purchase amount. The display unit 47 then ends the purchase information notification processing.

One Example of Display Screen

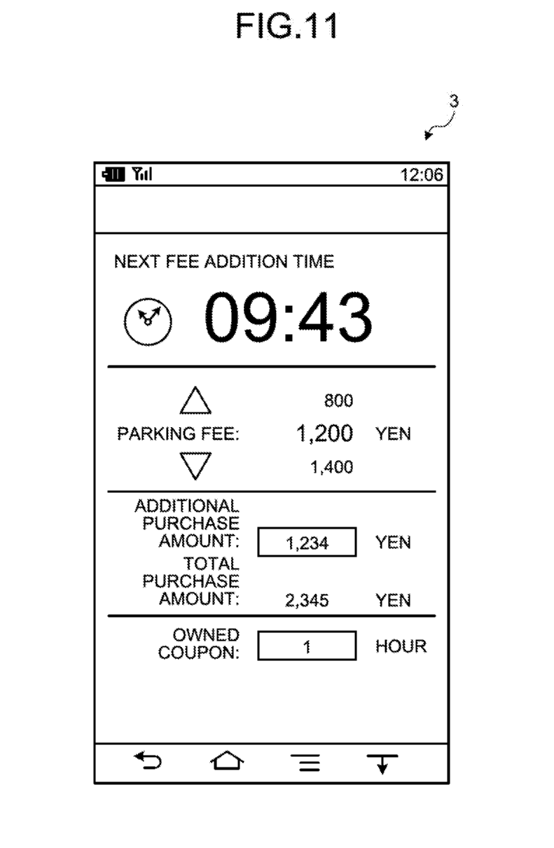

An example of a display screen in the terminal 3 will be explained next with reference to FIG. 11. FIG. 11 is a diagram illustrating an example of the display screen according to the first embodiment. As illustrated in FIG. 11, the display screen displays Next fee addition time, Current parking fee, Additional purchase amount, Total purchase amount, and Owned coupon. The next fee addition time corresponds to the time when the user enjoys the free service of the parking time. The additional purchase amount is an amount that one of the users in the group purchased goods most recently. The total purchase amount is the total of current purchase amounts in the group, and fluctuates when the additional purchase amount is added. When the total purchase amount fluctuates according to the additional purchase amount, the parking fee fluctuates according to the total purchase amount. The owned coupon can be increased or decreased, for example, on an hourly basis, and the parking fee fluctuates according to the increase/decrease of the owned coupon.

Sequence of Grouping Processing

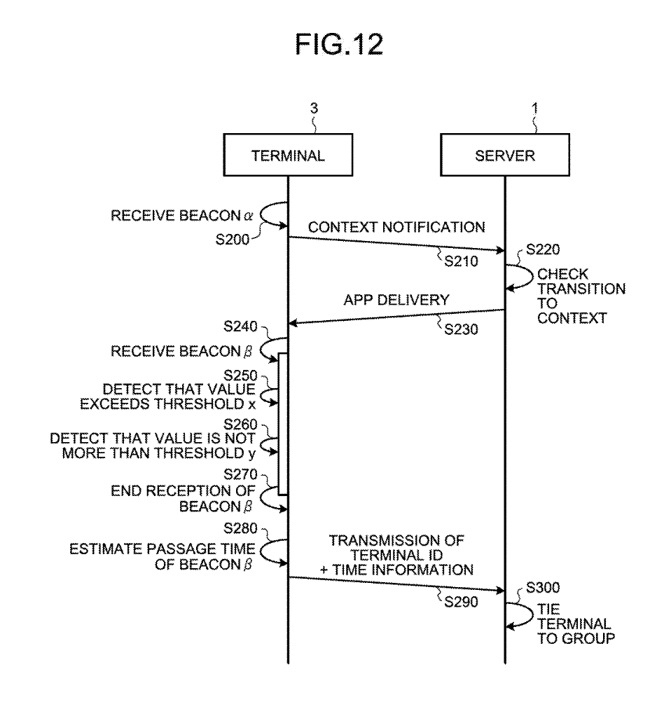

FIG. 12 is a diagram illustrating a sequence of the grouping processing according to the first embodiment.

When receiving the beacon α, the terminal 3 transmits context notification indicating transition to the context to the server 1 (S200, S210).

The server 1 having received the context notification checks the transition to the context, and delivers the grouping app to the terminal 3 (S220, S230).

The terminal 3 having received the grouping app activates the grouping app. When receiving the beacon β and detecting that the RSSI value exceeds the threshold x and is not more than the threshold y, the terminal 3 ends the reception of the beacon β (S240, S250, S260, S270). The terminal 3 then estimates a passage time of the beacon β (S280). That is, the terminal 3 extracts the time information at which the RSSI value becomes maximum as a feature amount. Then, the terminal 3 transmits the terminal ID and the time information to the server 1 (S290).

The server 1 uses the terminal ID and the time information to tie the terminal 3 to the group (S300). For example, the server 1 compares the pieces of time information acquired from the terminals 3 and groups the terminals associated with the same or approximate time information (feature amount).

Sequence of Purchase Information Processing

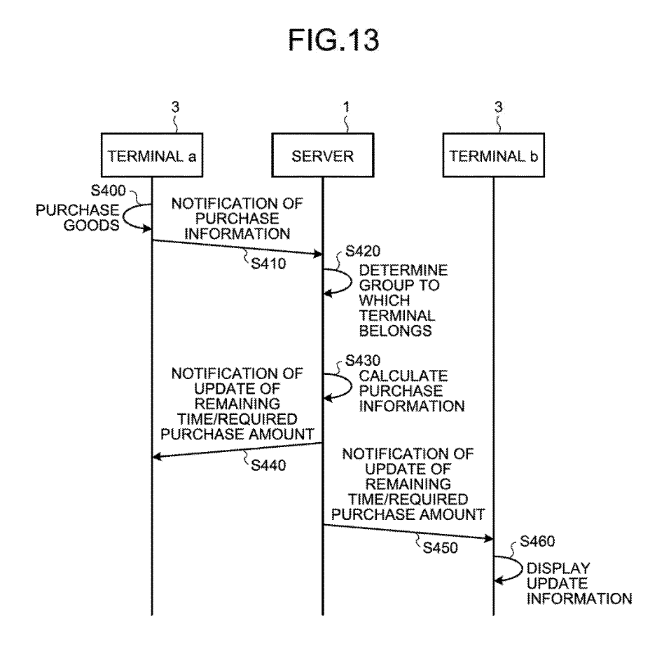

FIG. 13 is a diagram illustrating a sequence of the purchase information processing according to the first embodiment. It is assumed that the user of the terminal a3 and the user of the terminal b3 are in one car in FIG. 13.

It is assumed that the user of the terminal a3 has purchased the goods (S400). Then, the terminal a3 notifies the server 1 of the purchase information and the terminal ID (S410).

The server 1 uses the notified terminal ID to determine the group to which the terminal a3 belongs (S420). The server 1 then calculates the notified purchase information (S430). For example, the server 1 uses the notified purchase information in the group to recalculate a remaining time of a free parking time and a purchase amount needed for extension of a free parking time. The server 1 notifies the terminal a3 and the terminal b3 in the same group of update of remaining time/required purchase amount (S440, S450).

The terminal b3 of the user who does not purchase goods displays update information (S460).

### Advantageous Effect of First Embodiment

In this way, in the first embodiment, the server 1 receives the feature amount information including the times when the terminals 3 pass a specific location from the terminals 3. The server 1 stores the received feature amount information in the feature amount DB 12 in association with the terminal 3. The server 1 groups the terminals 3 associated with the same or the approximate feature amount information based on the received feature amount information and the feature amount information already stored in the feature amount DB 12. The server 1 stores the grouped terminals 3 in the group information storage unit 13 in association with the group ID for identifying the group. According to such a configuration, the server 1 can easily set temporary grouping of the terminals 3.

In the first embodiment, the server 1 updates each piece of purchase information of the terminals 3 in association with the group ID associated with each of the terminals 3. According to such a configuration, the server 1 can manage the total purchase amount in the same group unit. Thus, each user of the terminals 3 belonging to the group can learn the total purchase amount.

In the first embodiment, the server 1 notifies the updated purchase information and the additional information related to the purchase information to the terminals 3 associated with the updated purchase information. According to such a configuration, the server 1 is capable of causing the terminals 3 belonging to the group to learn the additional information such as the total purchase amount. In other words, the server 1 can share the purchase information and the additional information of the grouped terminals 3 with the terminals 3.

In the first embodiment, the server 1 groups the terminals by using the feature amount information including information of times at which the received intensity of the radio wave from the beacon becomes maximum when each terminal passes the beacon in a specific location. According to such a configuration, by using the information of the times at which the received intensity of radio wave from the beacon becomes maximum, the server 1 can easily group the terminals 3 having the reception intensity that becomes maximum at about the same time.

### [b] Second Embodiment

Incidentally, in the information processing system 9 including the server 1 according to the first embodiment, it has been explained that the server 1 receives the feature amount information including the times at which the terminals 3 pass the specific location from the terminals 3 and groups the terminals 3 passing the location at the same or approximate time. However, in the information processing system 9, the configuration is not limited thereto, and it may be configured that the server 1 receives the feature amount information including the times at which the terminals 3 pass the specific location from the terminals 3 and groups each of two pairs of terminals 3 passing the location at the same or approximate time. For example, there is a case in which two cars can pass a specific location along separate lanes. In a second embodiment, it is assumed that information of vibration when the terminals pass a specific second location is used as the feature amount information in addition to the time information when the terminals pass a specific first location. The first location and the second location may be the same as each other or may be different from each other.

A case of respectively grouping two pairs of the terminals 3 that receive the feature amount information including the times at which the terminals 3 pass a specific location from the terminals 3 and that pass the specific location at the same or the approximate time will be explained below.

Configuration of Information Processing System According to Second Embodiment

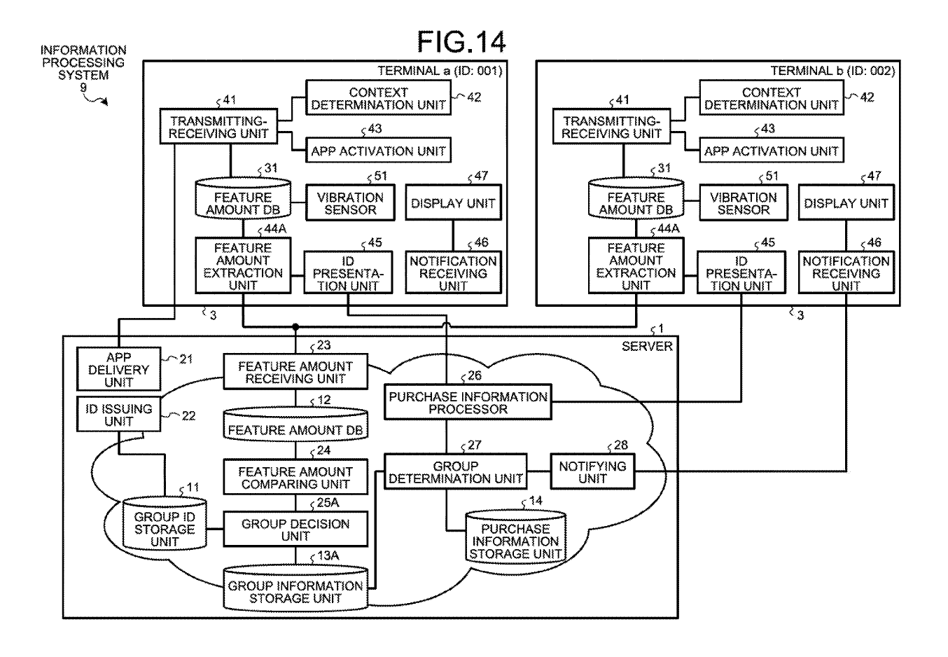

FIG. 14 is a block diagram illustrating a functional configuration of an information processing system including a server according to the second embodiment. The same reference signs are assigned to the same components as these of the information processing system 9 illustrated in FIG. 1, and explanation of overlapping components and operations is omitted. In the server 1, the second embodiment is different from the first embodiment in that the group decision unit 25 and the group information storage unit 13 are changed to a group decision unit 25A and a group information storage unit 13A respectively. In the terminal 3, the second embodiment is different from the first embodiment in that a vibration sensor 51 is added and the feature amount extraction unit 44 is changed to a feature amount extraction unit 44A.

The group decision unit 25A decides to group the terminals 3 associated with the same or the approximate feature amount as a result of comparison by the feature amount comparing unit 24. For example, the group decision unit 25A acquires the terminals 3 associated with the same or the approximate feature amount as a result of comparison by the feature amount comparing unit 24 from the feature amount DB 12 and decides to group the acquired terminals 3. In other words, the group decision unit 25A groups the terminals 3 having the same or the approximate vibration. Then, the group decision unit 25A estimates the time when a ticket is issued from the time at which the radio wave is received when the radio wave is transmitted by the beacon, and acquires a ticketing ID (group ID) issued at the estimated time. The group decision unit 25A stores the group ID in the group information storage unit 13A in association with the grouped terminal ID.

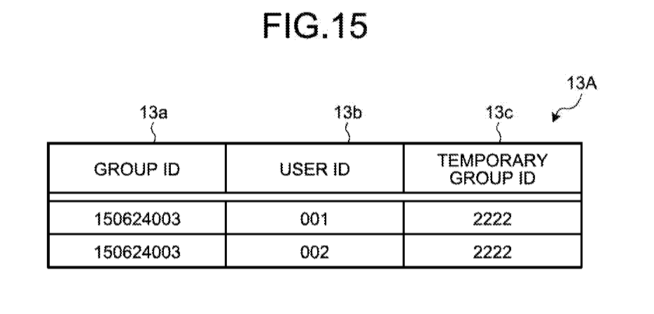

An example of a data structure of the group information storage unit 13A will be explained below with reference to FIG. 15. FIG. 15 is a diagram illustrating an example of the data structure of the group information storage unit according to the second embodiment. As illustrated in FIG. 15, the group information storage unit 13A stores the group ID 13a, the user ID 13b, and a temporary group ID 13c in association with each other. The group ID 13a indicates an ID for identifying a group. The user ID 13b indicates an ID for identifying a user corresponding to the terminal 3, for example, an ID managed by the terminal 3. The temporary group ID 13c is a temporary group ID when the terminals are grouped by vibration. As an example, when the group ID 13a is “150624003”, “001” is stored as the user 13b and “2222” is stored as the temporary group ID 13c. When the group ID 13a is “150624003”, “002” is stored as the user 13b and “2222” is stored as the temporary group ID 13c.

The vibration sensor 51 is a sensor used to acquire vibration, and is used to acquire characteristic acceleration when the terminal passes a predetermined protrusion.

The feature amount extraction unit 44A extracts characteristic vibrations and time information at which the characteristic vibrations are detected from the vibrations acquired by the vibration sensor 51. Here, the characteristic vibrations and the time information, at which the characteristic vibrations are detected, are the feature amounts. The feature amount extraction unit 44A transmits the information for the extracted vibrations, the extracted time information, and the user ID presented from the ID presentation unit 45 to the server 1. The user ID may be the terminal ID.

When receiving the radio wave from the beacon β, the feature amount extraction unit 44A stores the RSSI value and the received time information in the feature amount DB 31. The feature amount extraction unit 44A extracts the time information at which the RSSI value becomes maximum from the information stored in the feature amount DB 31. Here, the time information is the feature amount. The feature amount extraction unit 44A transmits the extracted time information and the user ID presented from the ID presentation unit 45 to the server 1. The user ID may be the terminal ID.

Application of Information Processing System

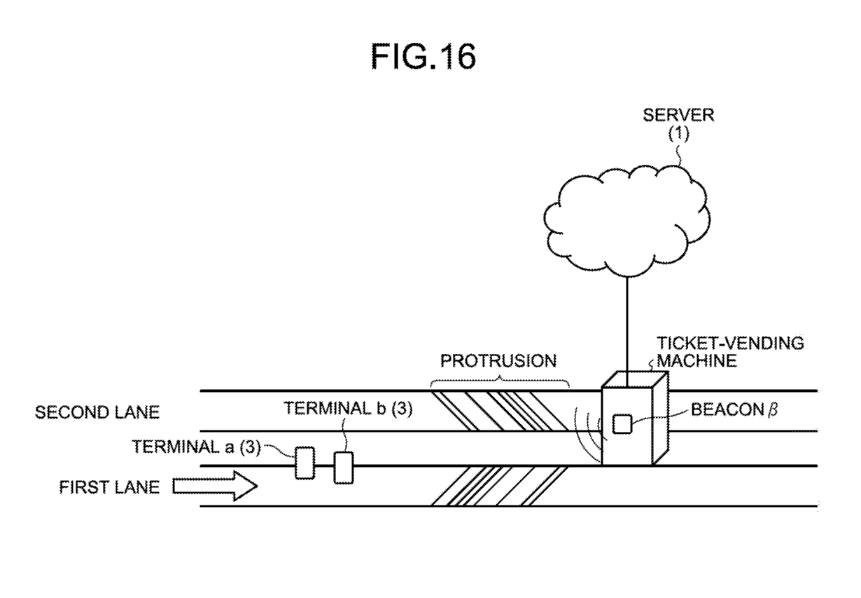

FIG. 16 is a diagram illustrating an application of the information processing system according to the second embodiment. As illustrated in FIG. 16, the server 1 is connected to the ticket-vending machine that issues a parking ticket when a car is parked. The beacon β is built in the ticket-vending machine. Protrusions are arranged in a first lane and a second lane in the direction opposite to the traveling direction of the car with respect to the ticket-vending machine. The protrusion in the first lane and the protrusion in the second lane are formed so that the protrusions cause characteristic vibrations to be different from each other. Although the beacon α which is different from the beacon β is disposed somewhere in the direction opposite to the traveling direction of the car with respect to the ticket-vending machine, it is not illustrated herein. The ticket-vending machine is assumed to be provided outside the server 1.

Under such circumstances, it is assumed that the car carrying the user with the terminal a (3) and the user with the terminal b (3) has progressed along the first lane and passed through the protrusion. Then, in each of the terminals a and b (3), the feature amount extraction unit 44A extracts characteristic vibrations and time information at which the characteristic vibrations are detected from the vibrations acquired by the vibration sensor 51. The feature amount extraction unit 44A transmits the information of the extracted vibrations, the extracted time information, and the user ID presented from the ID presentation unit 45 to the server 1.

The car goes further and is about to pass the beacon β.

Then, in each of the terminals a and b (3), the feature amount extraction unit 44A stores the RSSI value and detected time information in the feature amount DB 31 each time the radio wave of the beacon β is detected. The feature amount extraction unit 44A extracts the time information at which the RSSI value becomes maximum, as the feature amount, from the information stored in the feature amount DB 31. The feature amount extraction unit 44A then transmits the extracted time information and the user ID to the server 1.

In the ticket-vending machine, when the car is passing, the ID issuing unit 22 issues a group ID and transmits the issued group ID together with the time when it is issued to the server 1. The server 1 stores the group ID and the time information transmitted from the ticket-vending machine in the group ID storage unit 11.

In the server 1, when receiving the time information and the user ID transmitted from each of the terminals a and b (3), the feature amount receiving unit 23 stores the transmitted information in the feature amount DB 12. The feature amount comparing unit 24 compares pieces of vibration information stored in the feature amount DB 12 as feature amounts. The group decision unit 25A groups the terminal a (3) and the terminal b (3) in which the vibration information is the same as or approximate to each other as a result of comparison. The group decision unit 25A estimates the time at which the ticket is issued from the time at which the radio wave is received when the radio wave is transmitted from the beacon β, and acquires the group ID issued at the estimated time. The group decision unit 25A stores the group ID in the group information storage unit 13A in association with the grouped terminal a (3) and terminal b (3).

Flowchart of Grouping Processing in Server

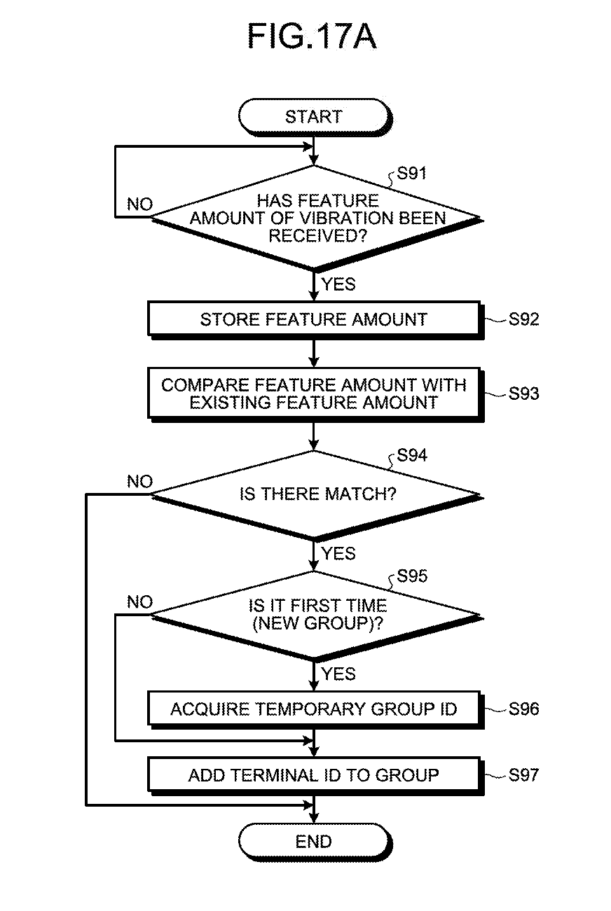

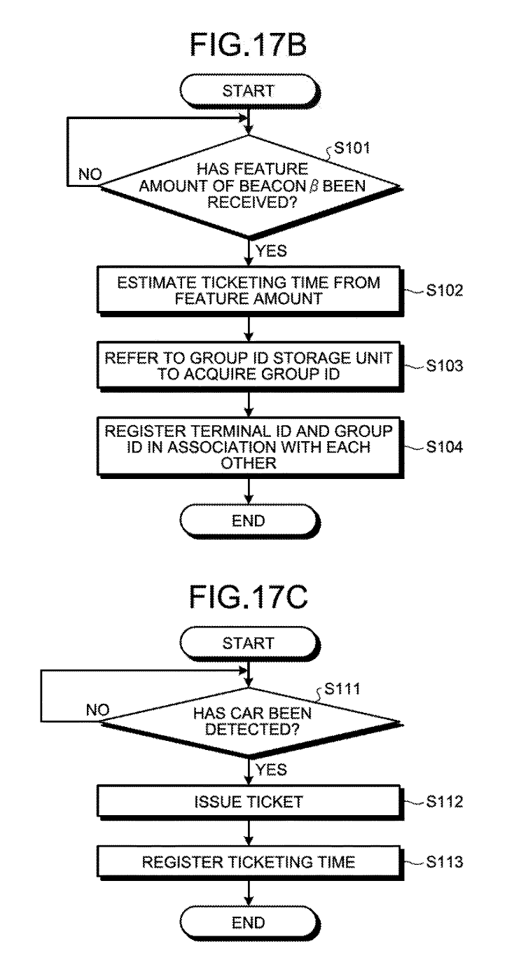

An example of the procedure of grouping processing in the server 1 according to the second embodiment will be explained next with reference to FIG. 17A to FIG. 17C. FIG. 17A to FIG. 17C are diagrams illustrating flowcharts of the grouping processing in the server according to the second embodiment.

As illustrated in FIG. 17A, in the server 1, the feature amount receiving unit 23 determines whether the feature amount of vibration has been received (Step S91). When it is determined that the feature amount of vibration has not been received (No at Step S91), the feature amount receiving unit 23 repeats the determination processing until the feature amount of vibration is received.

Meanwhile, when it is determined that the feature amount of vibration has been received (Yes at Step S21), the feature amount receiving unit 23 stores the feature amount information (Step S92). For example, the feature amount receiving unit 23 stores the feature amount in association with the terminal ID of the terminal 3 that transmits the feature amount in the feature amount DB 12 (Step S92). The feature amount comparing unit 24 compares the received feature amount with the existing feature amount in the feature amount DB 12 (Step S93).

The group decision unit 25A determines whether there is a matching feature amount as a result of comparison by the feature amount comparing unit 24 (Step S94). When it is determined that there is no matching feature amount (No at Step S94), the group decision unit 25A ends the grouping processing.

Meanwhile, when it is determined that there is a matching feature amount (Yes at Step S94), the group decision unit 25A determines whether the group is a first group (new group) (Step S95). When it is determined that the group is not the new group (No at Step S95), the group decision unit 25A proceeds to Step S97. Meanwhile, when it is determined that the group is the new group (Yes at Step S95), the group decision unit 25A acquires a temporary group ID (Step S96). The group decision unit 25A then proceeds to Step S97.

At Step S97, the group decision unit 25A adds the terminal ID associated with the matching feature amount to the group of the acquired temporary group ID (Step S97). The group decision unit 25A stores the terminal ID and the temporary group ID in the group information storage unit 13A in association with each other. The group decision unit 25A then ends the grouping processing.

As illustrated in FIG. 17B, in the server 1, the feature amount receiving unit 23 determines whether the feature amount of the beacon β has been received (Step S101). When it is determined that the feature amount of the beacon β has not been received (No at Step S101), the feature amount receiving unit 23 repeats the determination processing until the feature amount of the beacon β is received.

Meanwhile, when it is determined that the feature amount of the beacon β has been received (Yes at Step S101), the group decision unit 25A estimates a ticketing time from the time information indicating the feature amount (Step S102). The group decision unit 25A refers to the group ID storage unit 11 to acquire the group ID corresponding to the estimated ticketing time (Step S103).

The group decision unit 25A registers the terminal ID corresponding to the received feature amount and the group ID in the group information storage unit 13A in association with each other (Step S104). The group decision unit 25A then ends the grouping processing.

As illustrated in FIG. 17C, in the server 1, the ID issuing unit 22 determines whether the car has been detected (Step S111). The detection of the car is implemented by, for example, an infrared sensor. When it is determined that the car has not been detected (No at Step S111), the ID issuing unit 22 repeats the determination processing until the car is detected.

Meanwhile, when it is determined that the car has been detected (Yes at Step S111), the ID issuing unit 22 issues a ticketing ID (group ID) (Step S112). The ID issuing unit 22 registers the ticketing ID together with the ticketing time in the group ID storage unit 11 (Step S113). The ID issuing unit 22 then ends the grouping processing.

Flowchart of Feature Amount Extraction Processing of Terminal

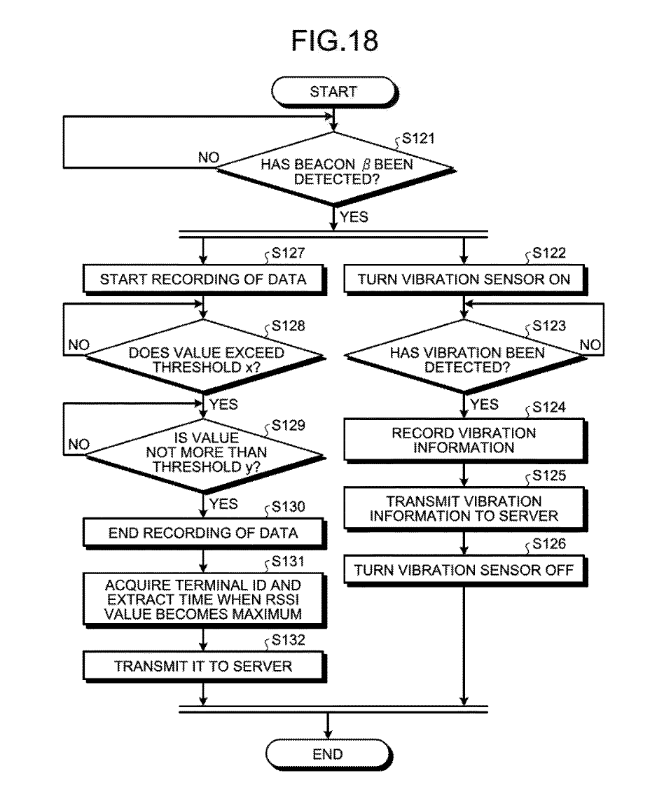

An example of the procedure of feature amount extraction processing of the terminal 3 according to the second embodiment will be explained next with reference to FIG. 18. FIG. 18 is a diagram illustrating a flowchart of the feature amount extraction processing of the terminal according to the second embodiment.

As illustrated in FIG. 18, in the terminal 3, the transmitting-receiving unit 41 determines whether the beacon β has been detected (Step S121). When it is determined that the beacon β has not been detected (No at Step S121), the transmitting-receiving unit 41 repeats the determination processing until the beacon β is detected.

When it is determined that the beacon β has been detected (Yes at Step S121), the transmitting-receiving unit 41 sets the vibration sensor 51 to ON (Step S122). The vibration sensor 51 then determines whether the vibration has been detected (Step S123). When it is determined that the vibration has not been detected (No at Step S123), the vibration sensor 51 repeats the determination processing until the vibration is detected.

Meanwhile, when it is determined that the vibration has been detected (Yes at Step S123), the feature amount extraction unit 44A records the detected vibration information in the feature amount DB 31 (Step S124). The feature amount extraction unit 44A then transmits the vibration information together with the time information at which the vibration is detected to the server 1 (Step S125). The feature amount extraction unit 44A sets the vibration sensor 51 to OFF (Step S126). The feature amount extraction unit 44A then ends the feature amount extraction processing.

When it is determined that the beacon β has been detected (Yes at Step S121), the transmitting-receiving unit 41 starts recording the data (Step S127). That is, the transmitting-receiving unit 41 stores the RSSI value indicating the radio field intensity when the radio wave is received from the beacon β and the received time information in the feature amount DB 31. The feature amount extraction unit 44A determines whether the RSSI value exceeds the threshold x (Step S128).

When it is determined that the RSSI value does not exceed the threshold x (No at Step S128), the feature amount extraction unit 44A repeats the determination processing until the RSSI value exceeds the threshold x. Meanwhile, when the RSSI value exceeds the threshold x (Yes at Step S128), the feature amount extraction unit 44A determines whether the RSSI value is not more than the threshold y (Step S129). When it is determined that the RSSI value is not less than the threshold y (No at Step S129), the feature amount extraction unit 44A repeats the determination processing until the RSSI value becomes not more than the threshold y.

Meanwhile, when it is determined that the RSSI value is not more than the threshold y (Yes at Step S129), the feature amount extraction unit 44A ends the recording of the data (Step S130). Then, the feature amount extraction unit 44A acquires the terminal ID of the own terminal 3 and extracts the time when the RSSI value is maximum from the feature amount DB 31 (Step S131).

The feature amount extraction unit 44A then transmits the feature amount information to the server 1 (Step S132). That is, the feature amount extraction unit 44A transmits the extracted time as the feature amount together with the terminal ID to the server 1. Then, the feature amount extraction unit 44A ends the feature amount extraction processing.

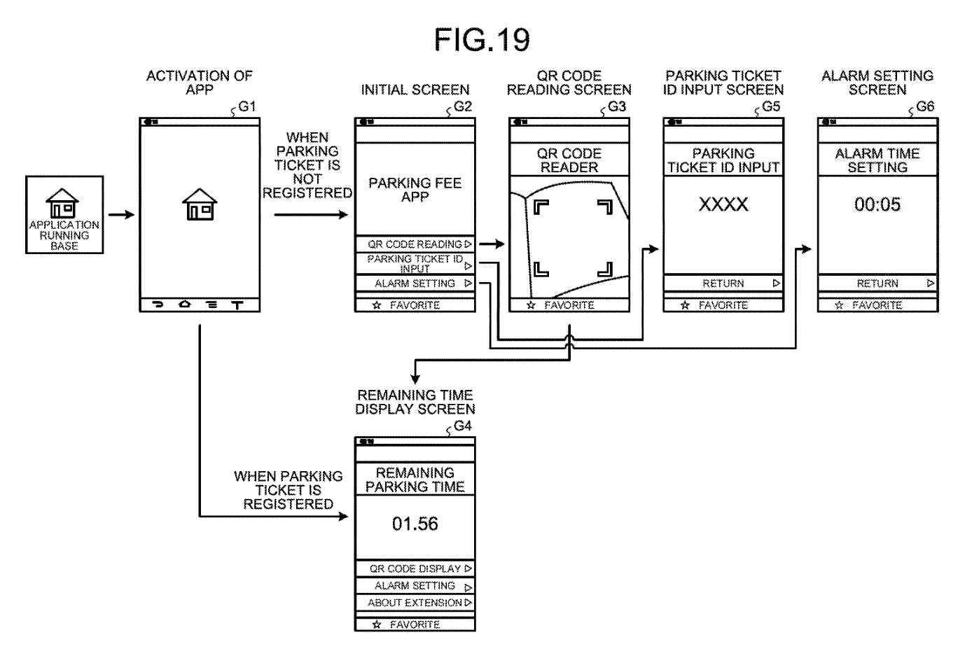

FIG. 19 is a diagram illustrating an example of a sequence of the display screen. As illustrated in FIG. 19, in the terminal 3, when an application running base corresponding to the grouping app delivered from the server 1 is activated, an app activation screen G1 is displayed. Subsequently, when the parking ticket ID is not registered in the server 1, an initial screen G2 is displayed. On the initial screen G2, a title of a parking fee application is displayed, and a menu such as QR code (registered trademark) reading, Parking ticket ID input, and Alarm setting are displayed.

On the initial screen G2, when the QR code reading is touched, a QR code reading screen G3 appears. Here, when a QR code reader reads the QR code, a remaining time display screen G4 appears. In other words, when the parking ticket ID is registered in the server 1, the additional information such as a remaining parking time is displayed. When the user of the terminal 3 purchases goods, and, for example, when the QR code on the screen is read by a sales clerk, the server 1 aggregates the purchase information into the group ID.

On the initial screen G2, when the parking ticket ID input is touched, a parking ticket ID input screen G5 appears. On the parking ticket ID input screen G5, the user backs up the read QR code, and inputs the parking ticket ID corresponding to the QR code. On the initial screen G2, when the alarm setting is touched, an alarm setting screen G6 appears. On the alarm setting screen G6, the user can set an alarm time.

### Advantageous Effect of Second Embodiment

In this way, in the second embodiment, the server 1 groups a plurality of terminals 3 by using the information for the time at which each reception intensity of radio waves sent from a beacon, when the terminals pass the beacon provided at a specific location, becomes maximum. In addition, the server 1 groups a plurality of terminals 3 by using the information for the vibration when each terminal passes any one of a plurality of areas which are in an upstream position or a downstream position of the location of the beacon and in which different vibrations are generated. According to such a configuration, by using the information of the times at which each received intensity of radio wave from the beacon located at the specific location becomes maximum, the server 1 can easily group the terminals 3 having the reception intensity that becomes maximum at about the same time. Moreover, by using the information for the vibrations of any one of the areas where different vibrations are generated, the server 1 can reliably group the terminals 3 even if the terminals pass the beacon located at the specific position at about the same time.

### Other

The first embodiment and the second embodiment have explained that, when receiving the radio wave from the beacon β used to acquire the feature amount, the transmitting-receiving unit 41 of the terminal 3 stores the RSSI value indicating the received radio field intensity and the received time information in the feature amount DB 31, and that the feature amount extraction units 44 and 44A of the terminal 3 extract the time information at which the RSSI value becomes maximum, as the feature amount, from the information stored in the feature amount DB 31. However, the processing of the feature amount extraction units 44 and 44A may be performed by the server 1. In other words, the transmitting-receiving unit 41 of the terminal 3 may transmit the RSSI value indicating the received radio field intensity, the received time information, and the terminal ID to the server 1, and the server 1 may use these pieces of information to extract the time information at which the RSSI value corresponding to the terminal ID becomes maximum, as the feature amount.

In the terminal 3 according to the first embodiment and the second embodiment, a case has been explained in which, when it is determined that the terminal has transitioned to the context based on the radio wave of the beacon α received by the transmitting-receiving unit 41, the context determination unit 42 causes the transmitting-receiving unit 41 to transmit the context notification to be server 1, and in which, when the transmitting-receiving unit 41 receives the grouping app, the app activation unit 43 activates the received grouping app. However, the app activation unit 43 is not limited to the case, and may be applied to a case in which a preinstalled grouping app is activated. In such a case, the terminal 3 may have a configuration in which the context determination unit 42 is deleted. The server 1 may have a configuration in which the app delivery unit 21 is deleted.

The components in the illustrated units are not always configured as physically illustrated ones. In other words, specific modes of how the units are distributed or integrated are not limited to the illustrated ones, and the whole of or part of the units can be configured by functionally or physically distributing or integrating them in arbitrary units according to various loads, usage conditions, and so on. For example, the feature amount comparing unit 24 and the group decision unit 25 may be combined with each other. The transmitting-receiving unit 41 may be divided into a first transmitting-receiving unit that receives the radio wave from the beacon α and transmits a context notification and a second transmitting-receiving unit that receives the radio wave from the beacon β. Moreover, the group ID storage unit 11, the feature amount DB 12, the group information storage unit 13, and the purchase information storage unit 14 may be connected to each other via a network as external devices of the server 1.

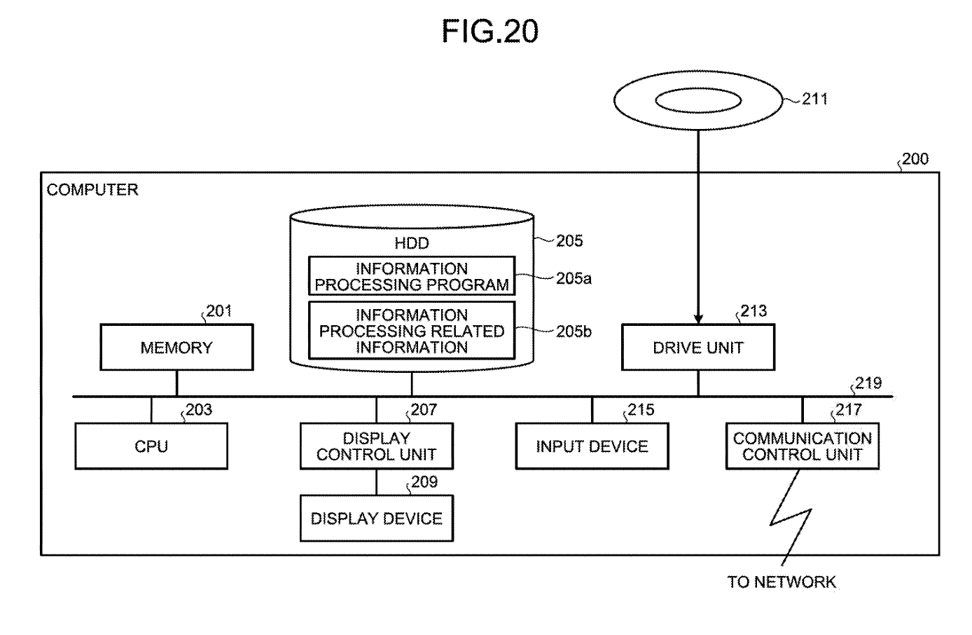

The various types of processing explained in the embodiments can be implemented by a computer such as a personal computer and a work station executing a prepared program. Therefore, an example of a computer executing an information processing program for implementing the same functions as these of the server 1 and the terminal 3 illustrated in FIG. 1 will be explained below. FIG. 20 is a diagram illustrating an example of a computer executing an information processing program.

As illustrated in FIG. 20, a computer 200 includes a central processing unit (CPU) 203 that executes various arithmetic processing, an input device 215 that receives input of data from a user, and a display control unit 207 that controls a display device 209. The computer 200 also includes a drive unit 213 that reads a program or so from a storage medium and a communication control unit 217 that exchanges data with other computer via a network. Furthermore, the computer 200 includes a memory 201 that temporarily stores various information and a hard disk drive (HDD) 205. The memory 201, the CPU 203, the HDD 205, the display control unit 207, the drive unit 213, the input device 215, and the communication control unit 217 are connected to each other by a bus 219.

The drive unit 213 is, for example, a device used for a removable disk 211.

The CPU 203 reads an information processing program 205a, loads it into the memory 201, and executes it as processes. The processes correspond to the functions of the server 1 and the terminal 3. Information processing related information 205b corresponds to the app delivery unit 21, the ID issuing unit 22, the feature amount receiving unit 23, the feature amount comparing unit 24, the group decision unit 25, the purchase information processor 26, the group determination unit 27, and the notifying unit 28 in the server 1. Then, for example, the removable disk 211 stores pieces of information such as the information processing program 205a.

Note that the information processing program 205a does not always have to be stored in the HDD 205 from the beginning. For example, the program is recorded in a “portable physical medium” such as a flexible disk (FD), a compact disk read only memory (CD-ROM), a digital versatile disk (DVD), a magneto-optical disk, and an integrated circuit (IC) card, each of which is inserted into the computer 200. The computer 200 may be configured to read the information processing program 205a from one of the mediums and execute the program.

According to one aspect, when each of a plurality of persons is to grasp a total purchase amount of the persons, temporal grouping of the persons can be performed easily.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a processor;
a storage unit, wherein the processor executes a process comprising:
receiving predetermined feature amount information including times when a plurality of terminals pass a specific location from the terminals;
storing the feature amount information received at the receiving in the storage unit in association with the terminal;
grouping terminals associated with same or approximate feature amount information based on the feature amount information received at the receiving and the feature amount information already stored in the storage unit; and
storing the terminals grouped at the grouping in the storage unit in association with an identifier for identifying a group.

2. The information processing device according to claim 1, the process further comprising:
managing each piece of purchase information of the terminals in association with the identifier indicating the grouped terminals.

3. The information processing device according to claim 2, the process further comprising:
notifying the purchase information managed at the managing and information related to the purchase information to the terminals belonging to the group of the identifier associated with the managed purchase information.

4. The information processing device according to claim 1, wherein
the feature amount information includes information for time at which the reception intensity of radio wave from a beacon when the terminal passes the beacon located at the specific location becomes maximum.

5. The information processing device according to claim 1, wherein
the feature amount information includes information for time at which the reception intensity of radio wave from a beacon when the terminal passes the beacon located at the specific location becomes maximum, and is information for vibration when the terminal passes any one of a plurality of areas which are present in an upstream position or a downstream position of the location of the beacon and in which different vibrations are generated.

6. An information processing system comprising:
a plurality of terminals; and
an information processing device, wherein the information processing device comprising:
a processor;
a storage unit, wherein the processor executes a process comprising:
receiving predetermined feature amount information including times at which a plurality of terminals pass a specific location from the terminals;
storing the feature amount information received at the receiving in the storage unit in association with the terminal;
grouping terminals associated with same or approximate feature amount information based on the feature amount information received at the receiving and the feature amount information already stored in the storage unit; and
storing the terminals grouped at the grouping in the storage unit in association with an identifier for identifying a group.

7. An information processing method to be performed by a computer, the information processing method comprising:
receiving predetermined feature amount information including times when a plurality of terminals pass a specific location from the terminals using a processor;
storing the received feature amount information in a storage unit in association with the terminal using the processor;
grouping terminals, based on the received feature amount and the feature amount information already stored in the storage unit, associated with the same or approximate feature amount information using the processor; and
storing the grouped terminals in the storage unit in association with an identifier for identifying a group using the processor.
